(19) United States
(12) Patent Application Publication
(10) Pub. No.: US 2006/0078752 A1
(43) Pub. Date: Apr. 13, 2006

(54) Line system for fluids and gases in a fuel cell

(75) Inventors: Guido Schmitz, Duelmen (DE); Harald Haeger, Freigericht (DE); Hans Ries, Marl (DE); Olivier Farges, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/246,274

(22) Filed: Oct. 11, 2005

(30) Foreign Application Priority Data
Oct. 11, 2004 (DE) 10 2004 049 652.8

(51) Int. Cl. B32B 27/34

(52) U.S. Cl. 428/474.4

(57) ABSTRACT

An element of a line system of a fuel cell, where the innermost layer I which is in contact with the medium being conveyed comprises a polyolefin molding composition which is joined to a layer II of an EVOH molding composition and the composite between the layer I and the layer II is produced by the contact surface of the layer I comprising a polyolefin containing functional groups selected from among acid anhydride groups, carboxylic acid groups, N-acyllactam groups, epoxide groups and trialkoxysilane groups. The element can be produced inexpensively and has a good barrier action against the medium being conveyed.

### BACKGROUND OF THE INVENTION

1. Field of the Invention

The present invention relates to an element of a line system of a fuel cell, which comes into contact with fluids and gases.

2. Description of the Background

Ever stricter environmental legislation is forcing the manufacturers of motor vehicles to contemplate new engine designs, since legislators are focusing ever more strongly on emissions, specifically NO, emissions. The fuel cell represents one possible alternative engine design.

Fuel cells in a multitude of embodiments have long been known. In all of them, a fuel is fed into the anode space and air or oxygen is fed into the cathode space. These reactants are reacted catalytically at the electrodes. Hydrogen, methanol, glycol, methane, butane, higher hydrocarbons, etc., can be used as fuel, but only hydrogen makes it possible to achieve current densities which are sufficiently high for a fuel cell operating at approximately room temperature to be able to be used for powering a motor vehicle. The other fuels can be reacted satisfactorily only in a medium- or high-temperature fuel cell, but this is a possibility first and foremost for stationary units. In a motor vehicle having an electric drive system which draws its power from a fuel cell unit which is to be operated using methanol or hydrocarbons, the fuel is therefore usually converted into hydrogen and carbon dioxide by means of steam at elevated temperature in a reformer, the reaction gas is freed of the by-product carbon monoxide and the hydrogen/CO₂ mixture is fed into the anode space. At present, the “proton exchange membrane fuel cell” in which a water-saturated acidic ion-exchange membrane is located between the porous, catalyst-containing electrodes is favored for this purpose. However, work on the direct oxidation of methanol, which would make a reformer superfluous, is being carried out for mobile applications, too.

The lines for the supply of fuel have hitherto usually been made of stainless steel. However, such lines are expensive.

JP 2002-213659 A discloses lines for hydrogen which comprise a polyolefin inner layer, an EVOH intermediate layer and a polyamide outer layer. The problem of the generally unsatisfactory adhesion between such layers has been partly recognized there in that the use of an adhesive, which is not specified in more detail, is addressed.

### SUMMARY OF THE INVENTION

In view of the foregoing, it is an object of the invention to provide an element of a line system of a fuel cell which has an improved barrier action against hydrocarbons, alcohols and hydrogen and in which, in addition, the individual layers themselves adhere firmly to one another.

In addition, it is most preferable that no components which can react with the electrolyte or the anode material are leached from the material of the line system in order to prevent poisoning of the catalyst or undesirable polarization.

The abovementioned object is achieved by an element of a line system of a fuel cell, in which the innermost layer I which is in contact with the medium being conveyed comprises a polyolefin molding composition which is joined to a layer II of an EVOH molding composition, with the composite additionally being able to comprise further layers selected from among

a) a layer III of a polyamide molding composition,

b) a layer IV of a molding composition comprising a functionalized polyolefin and

c) a layer V of a polyolefin molding composition in which the polyolefin is not functionalized,

and the composite between the layer I and the layer II is produced by the contact surface of the layer I comprising a polyolefin containing functional groups selected from among acid anhydride groups, carboxylic acid groups, N-acyllactam groups, epoxide groups and trialkoxysilane groups.

Thus, the present invention provides an element of a line system of a fuel cell, comprising

an innermost layer I which (1) is to be in contact with a medium to be conveyed, (2) comprises a polyolefin molding composition and (3) is joined to a layer II comprising an EVOH molding composition,

wherein the polyolefin in the polyolefin molding composition contains at least one functional group selected from the group consisting of acid anhydride groups, carboxylic acid groups, N-acyllactam groups, epoxide groups and trialkoxysilane groups, and

wherein the innermost layer I is joined to the layer II by a composite produced by a contact surface of the layer I comprising the polyolefin in contact with layer II.

### DETAILED DESCRIPTION OF THE INVENTION

Such elements are, for example, a pipe or a tubular molding which can be a multilayer pipe in which the innermost layer comprises the polyolefin molding composition. Such a pipe or tubular molding can either be produced as a smooth pipe which may, if desired, subsequently be thermoformed, or as a corrugated pipe. Mention may also be made of components in which fluids are stored, for instance storage containers. Further elements are, for example, connecting elements, for instance quick connectors, adapters, filters, components of pumps or components of valves.

The elements of the invention can be produced by means of the customary processes for plastics processing, for example by means of coextrusion (e.g. multilayer pipe), blowmolding or special forms thereof, e.g. suction blowmolding or 3D parison manipulation, in which the preform is coextruded, injection molding and special modifications thereof, e.g. the fluid injection technique, or rotational sintering.

In a first embodiment, the molding composition of the layer I consists entirely of a polyolefin containing functional groups selected from among acid anhydride groups, carboxylic acid groups, N-acyllactam groups, epoxide groups and trialkoxysilane groups.

In a second embodiment, the molding composition of the layer I comprises a mixture of an unfunctionalized polyolefin and a polyolefin containing these functional groups. The basic skeleton of the two polyolefins can be identical or different. In the latter case, though, the two polyolefins have to be sufficiently similar for them to be at least partially compatible, since otherwise the mechanical properties of the mixture are adversely affected.

In a third embodiment, the layer I is divided into

a) a sublayer Ia comprising an unfunctionalized polyolefin which is located on the inside and is in direct contact with the medium being conveyed and

b) a subsequent sublayer Ib which comprises the abovementioned polyolefin having the functional groups and adheres directly to the layer II. The sublayer Ib can either consist entirely of the polyolefin containing functional groups or be a mixture as described above for the second embodiment.

In a fourth embodiment, which is derived from the third embodiment, the molding composition of the sublayer Ib comprises not only the polyolefin containing functional groups but also a further polymer selected from among EVOH and polymers which are compatible with EVOH, e.g. PA6. In addition, unfunctionalized polyolefin may also be present in order to ensure adhesion to the sublayer Ia.

The element of the invention can, for example, have the following layer structure, from the outside inward:

II/I

III/II/I

III/II/Ib/Ia

IV/II/I

V/IV/II/Ib/Ia

IV/II/Ib/Ia

Polyamides suitable for the layer III are known to those skilled in the art and many types are commercially available. For example, it is possible to use PA46, PA66, PA68, PA610, PA612, PA88, PA810, PA100, PA1012, PA1212, PA6, PA7, PA8, PA9, PA10, PA11, PA12, copolyamides based thereon, branched polyamine-polyamide copolymers and mixtures thereof. As regards suitable homopolyamides and copolyamides and also suitable polyamine-polyamide copolymers, reference may be made to US-A-2002/142118, US-A-2002/082352 and U.S. Pat. No. 6,794,048, the disclosure of which is hereby expressly incorporated by reference.

The polyamide molding composition can contain a maximum of about 50% by weight of additives selected from among impact-modifying rubber and/or customary auxiliaries and additives.

Impact-modifying rubbers for polyamide molding compositions are known. They contain functional groups derived from unsaturated functional compounds which have either been copolymerized into the main chain or been grafted onto the main chain. The most widely used impact-modifying rubber is EPM or EPDM rubber onto which maleic anhydride has been grafted by a free-radical mechanism. Such rubbers can also be used together with an unfunctionalized polyolefin such as isotactic polypropylene, as described in EP-A-0 683 210, incorporated herein by reference.

In addition, the molding composition can further comprise small amounts of auxiliaries or additives which are needed to obtain particular properties. Examples are plasticizers, pigments or fillers such as carbon black, titanium dioxide, zinc sulfide, silicates or carbonates, processing aids such as waxes, zinc stearate or calcium stearate, flame retardants such as magnesium hydroxide, aluminum hydroxide or melamine cyanurate, glass fibers, antioxidants, UV stabilizers and also additives which impart to the product antielectrostatic properties or electrical conductivity, e.g. carbon fibers, graphite fibrils, stainless steel fibers or conductive carbon black.

In one possible embodiment, the molding composition comprises from 1 to 25% by weight of plasticizer, particularly preferably from 2 to 20% by weight and very particularly preferably from 3 to 15% by weight.

Plasticizers and their use in polyamides are known. A general overview of plasticizers which are suitable for polyamides may be found in Gächter/Müller, Kunststoffadditive, C. Hanser Verlag, 2nd Edition, p. 296.

Customary compounds suitable as plasticizers are, for example, esters of p-hydroxybenzoic acid having from 2 to 20 carbon atoms in the alcohol component or amides of arylsulfonic acids having from 2 to 12 carbon atoms in the amine component, preferably amides of benzenesulfonic acid.

Possible plasticizers are, inter alia, ethyl p-hydroxybenzoate, octyl p-hydroxybenzoate, i-hexadecyl p-hydroxybenzoate, N-n-octyltoluenesulfonamide, N-n-butylbenzenesulfonamide and N-2-ethylhexylbenzenesulfonamide.

The polyolefin of the sublayer Ia or of the layer V is, for example, polyethylene or polypropylene. It is in principle possible to use any commercial type. Examples of possible polyolefins are: linear polyethylene of high, medium or low density, LDPE, isotactic or atactic homopolypropylene, random copolymers of propene with ethene and/or 1-butene, ethylene-propylene block copolymers and the like. The polyolefin can further comprise an impact-modifying component such as EPM or EPDM rubber or SEBS. In addition, the customary auxiliaries and additives may be present. The polyolefin can be prepared by any known process, for example by the Ziegler-Natta process, by the Phillips process, by means of metallocenes or by a free-radical mechanism.

The molding composition of these layers can be crosslinked according to the prior art so as to achieve an improvement in the mechanical properties, e.g. the low-temperature impact toughness, the heat distortion resistance or the tendency to undergo creep, or the permeability. Crosslinking is carried out, for example, by radiation crosslinking or by means of moisture crosslinking of polyolefin molding compositions containing silane groups.

In the case of the polyolefin containing functional groups of the layer I or of the sublayer Ib, the functional groups can be introduced either by copolymerization of a suitable monomer together with the olefin or by means of a grafting reaction. In the grafting reaction, a previously produced polyolefin is reacted in a known manner with an unsaturated, functional monomer and advantageously a free-radical donor at elevated temperature.

The previously produced polyolefin can be one of the type which is also suitable for the sublayer Ia or the layer V. Suitable unsaturated functional monomers are, for example, maleic anhydride, itaconic anhydride, acrylic acid, methacrylic acid, N-methacryloylcaprolactam, glycidyl acrylate, glycidyl methacrylate, vinyltrimethoxysilane, vinyltriethoxysilane and methacryloyloxypropyltrimethoxysilane.

Suitable copolymers in which the functional monomer is built into the main chain are, for example, ethylene-glycidyl (meth)acrylate copolymers, ethylene-itaconic anhydride copolymers, ethylene-butyl acrylate-maleic anhydride copolymers, ethylene-vinyl acetate-maleic anhydride copolymers and ethylene-(meth)acrylic acid-(meth)acrylic ester copolymers.

EVOH has been known for a long time. It is a copolymer of ethylene and vinyl alcohol and is sometimes also referred to as EVAL. The ethylene content of the copolymer is generally from 25 to 60 mol %, in particular from 28 to 45 mol %. Many types are commercially available. For example, reference may be made to the company brochure “Introduction to Kuraray EVAL™ Resins”, Version 1.2/9810, from Kuraray EVAL Europe.

The EVOH is generally prepared by hydrolysis of ethylene-vinyl acetate copolymers. For reasons of improved processibility, it is also possible, according to the invention, to use a partially hydrolyzed ethylene-vinyl acetate copolymer in which the hydrolysis has been carried out to an extent of at least 60%, preferably to an extent of at least 80% and particularly preferably to an extent of at least 90%. Improved processibility can also be achieved by blending in of polyvinyl acetate, ethylene-polyvinyl acetate copolymers or polyamides. In addition, the EVOH molding composition can comprise all further additives known from the prior art, for example sheet silicates. The proportion of EVOH in the molding composition should be at least 50% by weight, preferably at least 60% by weight, particularly preferably at least 75% by weight and very particularly preferably at least 90% by weight.

One of the layers of the composite, preferably the innermost layer, can be made antielectrostatic, which can be effected according to the prior art by mixing carbon black, graphite fibrils or other suitable conductive particles into the molding composition.

The line system of the invention or its individual elements can be produced inexpensively. Furthermore, it also has a low weight, which is particularly advantageous for mobile use.

The medium to be conveyed may be hydrogen, methanol, glycol, methane, butane, higher hydrocarbons, etc. Hydrogen is particularly preferred.

The invention also provides a fuel cell system comprising an element according to the invention, for example for the engine of a motor vehicle.

This application is based on German application No. 102004049652.8, filed Oct. 11, 2004, and incorporated herein by reference.

1. An element of a line system of a fuel cell, comprising
an innermost layer I which (1) is for contact with a medium to be conveyed, (2) comprises a polyolefin molding composition and (3) is joined to a layer II which comprises an EVOH molding composition,
wherein the polyolefin in the polyolefin molding composition contains at least one functional group selected from the group consisting of acid anhydride groups, carboxylic acid groups, N-acyllactam groups, epoxide groups and trialkoxysilane groups, and
wherein the innermost layer I is joined to the layer II by a composite produced by a contact surface of the layer I comprising the polyolefin in contact with layer II.

2. The element of a line system of a fuel cell of claim 1, which further comprises one or more of the following layers:
a) a layer III of a polyamide molding composition,
b) a layer IV of a molding composition comprising a functionalized polyolefin, and/or
c) a layer V of a polyolefin molding composition in which the polyolefin is not functionalized.

3. The element of a line system of a fuel cell of claim 1, which is a multilayer pipe, a storage container, a connecting element, an adapter, a filter, a component of a pump or a component of a valve.

4. The element of a line system of a fuel cell of claim 1, wherein at least one of the layers is antielectrostatic.

5. The element of a line system of a fuel cell of claim 1, wherein the functional group is an acid anhydride group.

6. The element of a line system of a fuel cell of claim 1, wherein the functional group is a carboxylic acid group.

7. The element of a line system of a fuel cell of claim 1, wherein the functional group is an N-acyllactam group.

8. The element of a line system of a fuel cell of claim 1, wherein the functional group is an epoxide group.

9. The element of a line system of a fuel cell of claim 1, wherein the functional group is a trialkoxysilane group.

10. The element of a line system of a fuel cell of claim 1, wherein the polyolefin molding composition also comprises an unfunctionalized polyolefin.

11. The element of a line system of a fuel cell of claim 1, wherein the EVOH molding composition contains at 50% by weight of EVOH.

12. The element of a line system of a fuel cell of claim 1, wherein layer (I) is antielectrostatic.

13. The element of a line system of a fuel cell of claim 1, which is in contact with the medium.

14. A fuel cell system comprising the element of claim 1.

15. A fuel cell system for the engine of a motor vehicle, which comprises the element of claim 1.

16. A method of making the element of a line system of a fuel cell of claim 1, comprising combining layer (I) and layer (II).

17. A method of delivering a medium in a fuel cell system, comprising contacting the medium with the element of the fuel cell system of claim 14.

18. A method of delivering a medium in a fuel cell system, comprising contacting the medium with the element of the fuel cell system of claim 15.
